(19) United States
(12) Patent Application Publication
(10) Pub. No.: US 2008/0037857 A1
(43) Pub. Date: Feb. 14, 2008

(54) Method of classifying directional defects on an object and apparatus for performing the same

(76) Inventors: Young-Kyu Lim, Hwaseong-si (KR); Byung-Am Lee, Suwon-si (KR); Je-Kwon Park, Yongin-si (KR); Jae-Kyun Ko, Osan-si (KR); Kyu Lee, Gwangju-si (KR); Kyoung-Hee Park, Gimhae-si (KR)

Correspondence Address: F. CHAU & ASSOCIATES, LLC, 130 WOODBURY ROAD, WOODBURY, NY, 11797, US

(21) Appl. No.: 11/739,900

(22) Filed: Apr. 25, 2007

(30) Foreign Application Priority Data
Jun. 16, 2006 (KR) 2006-54410

(51) Int. Cl. G06K 9/00

(52) U.S. Cl. 382/141

(57) ABSTRACT

In a method of classifying directional defects on an object straight lines are drawn from any defect among all defects on the object toward adjacent defects. At least three defects that are positioned within an allowable angle from the straight lines are classified as directional defects. Thus, only the directional defects among all the defects on the semiconductor substrate may be accurately classified after performing a chemical mechanical polishing (CMP) process, so that the CMP process may be effectively managed.

### CROSS-REFERENCE TO RELATED APPLICATION

This application claims priority under 35 USC §119 to Korean Patent Application No. 2006-54410 filed on Jun. 16, 2006, the contents of which are herein incorporated by reference in its entirety for all purposes.

### BACKGROUND OF THE INVENTION

1. Technical Field

Exemplary embodiments of the present invention relate to a method of classifying directional defects and an apparatus for performing the same. More particularly, exemplary embodiments of the present invention relate to a method of classifying directional defects such as scratches, which are generated in a chemical mechanical polishing (CMP) process, on a semiconductor substrate and an apparatus for performing the method.

2. Discussion of Related Art

Generally, a semiconductor device is manufactured by performing a deposition process, a patterning process, a CMP process, a cleaning process, and the like. Various defects are generated on a semiconductor substrate during the above-mentioned processes.

The CMP process is used for planarizing a layer on the semiconductor substrate. A CMP apparatus for performing the CMP process includes a platen placed on a station. A polishing pad for polishing the semiconductor substrate is attached to an upper face of the platen. A slum line for supplying shiny to an upper face of the polishing pad is mounted to the station. Typically, a pad conditioner for removing foreign substances on the polishing pad is provided to the station.

A polishing head is arranged over the platen, and the polishing head is rotated in a direction opposite to a direction in which the platen rotates. The polishing head holds the semiconductor substrate using vacuum to place the semiconductor substrate over the polishing pad. Further, the polishing head compresses the semiconductor substrate using pneumatic pressure so that the semiconductor substrate makes close contact with the polishing pad. Thus, a vacuum line for providing the vacuum and a pneumatic line for providing the pneumatic pressure to the polishing head are connected to the polishing head.

Because the polishing pad and the polishing head are rotated in opposite directions, directional defects such as micro-scratches that extend along the rotational direction of the polishing pad and the polishing head may be generated on the semiconductor substrate due to the presence of foreign particles. The micro-scratches may cause the failure of a pattern on the semiconductor substrate.

Other defects generated, however, prior to proceeding with the CMP process, as well as the micro-scratches generated while performing the CMP process, remain on the semiconductor substrate. Therefore, to effectively manage the CMP process, it is necessary to classify the micro-scratches generated in the CMP process in relation to the other kinds of defects on the semiconductor substrate.

Conventional methods of classifying micro-scratches caused by a CMP process include a monitoring method using a defect source analysis, a monitoring method using clustering, a monitoring method using a non-pattern, and a monitoring method using a review.

When the micro-scratches caused by the CMP process are classified by using the conventional methods, however, the micro-scratches may not be accurately classified from the other kinds of defects on the semiconductor substrate. Further, it takes much more time and money to use the conventional methods to classify the micro-scratches from the other defects, thereby greatly decreasing a productivity of a semiconductor device.

### SUMMARY OF THE INVENTION

Exemplary embodiments of the present invention provide a method of classifying directional defects caused by a CMP process from the other kinds of defects on a semiconductor substrate.

Exemplary embodiments of the present invention also provide an apparatus for performing the above-mentioned method.

In a method of classifying directional defects on an object in accordance with an exemplary embodiment of the present invention, straight lines are drawn from any defect of a number of defects on the object toward adjacent defects. At least three defects that are positioned within an allowable angle from the straight lines are differentiated as directional defects.

According to an exemplary embodiment, the straight lines are drawn on a slant with respect to diametrical lines to exclude defects that are located on diametrical lines of the object from the directional defects.

According to an exemplary embodiment, intervals between the directional defects are measured. When an interval exceeds an allowable length, a corresponding directional defect spaced apart by the excess length is excluded from the directional defects.

In an exemplary embodiment, defects that are not positioned on curvature lines with respect to a center point of the object are excluded from the directional defects.

According to an exemplary embodiment, the directional defects are, again, sub-classified by inclined angles of the straight lines.

In a method of classifying directional defects on a semiconductor substrate in accordance with an exemplary embodiment of the present invention, straight lines are drawn from any defect on the semiconductor substrate toward adjacent defects. At least three defects that are positioned within an allowable angle from the straight lines are classified as preliminary first directional defects. Intervals between the preliminary first directional defects are then measured. When an interval exceeds an allowable length, a corresponding directional defect spaced apart by the excess length is excluded from the preliminary first directional defects to obtain preliminary second directional defects. Defects located on diametrical lines of the semiconductor substrate are excluded from the preliminary second directional defects to obtain preliminary third directional defects. Detects that are not positioned on curvature lines with respect to a center point of the semiconductor substrate are excluded from the preliminary third directional defects to obtain final directional defects.

In a method of classifying directional defects on a semiconductor substrate in accordance with an exemplary embodiment of the present invention, straight lines not passing through a center point of the semiconductor substrate are drawn from any detect on the semiconductor substrate toward an adjacent defect. At least three defects that are positioned within an allowable angle from the straight lines are classified as preliminary first directional defects. Intervals between the preliminary first directional defects are then measured. When an interval exceeds an allowable length, a corresponding directional defect spaced apart by the excess length is excluded from the preliminary first directional defects to obtain preliminary second directional defects. Defects that are not positioned on curvature lines with respect to a center point of the semiconductor substrate are excluded from the preliminary second directional defects to obtain final directional defects.

An apparatus for classifying directional defects on an object in accordance with an exemplary embodiment of the present invention includes a drawing unit and a defect-classifying unit. The drawing unit draws straight lines from any defect on the object toward adjacent defects. The defect-classifying unit classifies at least three defects positioned within an allowable angle from the other directional defects in the straight lines.

According to an exemplary embodiment, an interval-measuring unit measures intervals between the directional defects. When an interval is greater than an allowable length, the defect-classifying unit excludes a corresponding directional defect spaced apart by the excess length from the directional defects.

According to an exemplary embodiment of the present invention, after performing a CMP process, only the directional defects among all the defects on the semiconductor substrate may be accurately classified so that the CMP process may be effectively managed.

### BRIEF DESCRIPTION OF THE DRAWINGS

Exemplary embodiments of the present invention will be understood in more detail from the following descriptions taken in conjunction with the accompanying drawings wherein:

FIG. 1 is a block diagram illustrating an apparatus for classifying directional defects in accordance with an exemplary embodiment of the present invention;

FIG. 2 is a flow chart illustrating a method of classifying directional defects using the apparatus in FIG. 1 in accordance with an exemplary embodiment of the present invention;

FIG. 3 is a plan view illustrating a process for drawing straight lines on a semiconductor substrate;

FIG. 4 is an enlarged plan view illustrating a process for classifying preliminary first directional defects;

FIG. 5 is an enlarged plan view illustrating a process for classifying preliminary second directional defects;

FIG. 6 is an enlarged plan view illustrating a process for classifying preliminary third directional defects;

FIG. 7 is a plan view illustrating a process for classifying final directional defects;

FIG. 8 is a plan view illustrating a process for sub-classifying the final directional defects;

FIG. 9 is a flow chart illustrating a method of classifying directional defects using the apparatus in FIG. 1 in accordance with an exemplary embodiment of the present invention; and

FIGS. 10 and 11 are graphs illustrating conformity of micro-scratches using the present invention.

### DESCRIPTION OF EXEMPLARY EMBODIMENTS

The present invention is described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art.

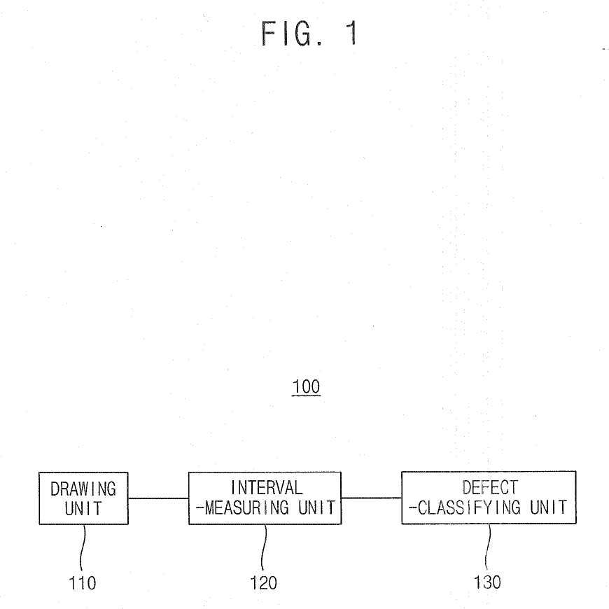

FIG. 1 is a block diagram illustrating an apparatus for classifying directional defects in accordance with an exemplary embodiment of the present invention.

Referring to FIG. 1, an apparatus 100 for classifying directional defects from other defects in accordance with an exemplary embodiment includes a drawing unit 110, an interval-measuring unit 120 and a defect-classifying unit 130. The apparatus 100 classifies directional defects such as micro-scratches, which are formed at a surface portion of a semiconductor substrate by slurry and/or other particles during a CMP process, from other defects present on the semiconductor substrate. That is, since a polishing pad and the semiconductor substrate are rotated relative to each other in the CMP process, the micro-scratches caused by the CMP process have discernable directions.

The drawing unit 110 draws virtual straight lines from any defect among all the defects on the semiconductor substrate toward other adjacent defects.

The interval-measuring unit 120 measures intervals between defects on the straight lines.

The defect-classifying unit 130 sub-classifies at least three defects placed on the straight line as preliminary first directional defects, that is, the micro-scratches caused by the CMP process. In this exemplary embodiment, since two defects on the straight line may not have the direction, at least three defects are classified as the preliminary first directional defects.

The preliminary first directional defects may not be positioned accurately on the straight line. Thus, the defect-classifying unit 130 sub-classifies at least three defects, which are located within an allowable angle with respect to the straight line, as the preliminary first directional defects. In this exemplary embodiment, when the allowable angle is above about 1.5°, corresponding defects within an angle of about 1.5° may not be regarded as the directional defects. Thus, in this exemplary embodiment, the allowable angle is about ±1.5 with respect to the straight line.

The interval-measuring unit 120 measures the intervals between the preliminary first directional defects. That is, the interval measuring unit 120 sequentially measures a first interval between a first defect and a second defect, a second interval between the second defect and a third defect, a third interval between the third defect and a fourth defect, and so on, among the preliminary first directional defects.

For example, the first interval and the second interval may be within an allowable length. On the other hand, when the third interval exceeds the allowable length, the defect-classifying unit 130 excludes the fourth defect from the preliminary first directional defects to obtain preliminary second directional defects without having defects spaced apart by the excessive length.

In this exemplary embodiment, when the allowable length is above about 40 μm, a corresponding defect spaced apart by above 40 μm may be regarded as a defect that may be generated by other causes, but not by the CMP process. More specifically, any defect present among the polishing particles forms the micro-scratches on the semiconductor substrate. The micro-scratches are arranged having predetermined intervals with each other. Thus, when a micro-scratch is spaced apart from another micro-scratch by the predetermined interval, the corresponding micro-scratch may be regarded as a defect generated by some other cause. Therefore, the predetermined interval is restricted within the allowable length to exclude tire defect spaced apart by the excessive length from the preliminary first directional defects. In this exemplary embodiment, the allowable length of about 40 μm is set by measuring intervals between micro-scratches on a plurality of semiconductor substrates on which CMP processes have been carried out.

The drawing unit 110 draws diametrical lines, which pass through a center point of the semiconductor substrate, to the preliminary second directional defects. As described above, because the polishing pad and the semiconductor substrate are rotated relative to each other in the CMP process, the directions of the directional defects caused by the CMP process may correspond to curvature lines with respect to the center point of the semiconductor substrate. That is, defects on the diametrical lines of the semiconductor substrate may not be regarded as directional defects due to performing the CMP process.

Therefore, the defect-classifying unit 130 excludes the defects on the diametrical lines of the semiconductor substrate from the preliminary second directional defects to obtain preliminary third directional defects without the defects on the diametrical lines.

Alternatively, the drawing unit 110 may draw the straight lines on a slant with respect to the diametrical lines of the semiconductor substrate. That is, the drawing unit 110 may draw the straight lines so that they do not pass through the center point of the semiconductor substrate. Thus, since the straight lines do not include the diametrical lines passing through the center point of the semiconductor substrate, the defect-classifying unit 130 does not carry out the process for excluding the defects on the diametrical lines.

Furthermore, as described above, the directional defects due to the CMP process are located on the curvature lines with respect to the center point of the semiconductor substrate. Thus, the drawing unit 110 draws the curvature lines connecting the preliminary third directional defects to each other.

The defect-classifying unit 130 excludes defects, which are not located on the curvature lines, from the preliminary third directional defects to obtain final directional defects including defects present only on the curvature lines.

Additionally, the defect-classifying unit 130 sub-sub-classifies the final directional defects by inclined angles of the straight lines. In this exemplary embodiment, the sub-differentiated final directional defects by the inclined angles of the straight lines may be generated by different particles. Thus, the number of micro-scratches generated in the CMP process may be accurately obtained from the numbers of the sub-differentiated final directional defects.

According to this exemplary embodiment, the number of directional defects generated only in the CMP process may be accurately recognized, so that the CMP process may be effectively managed.

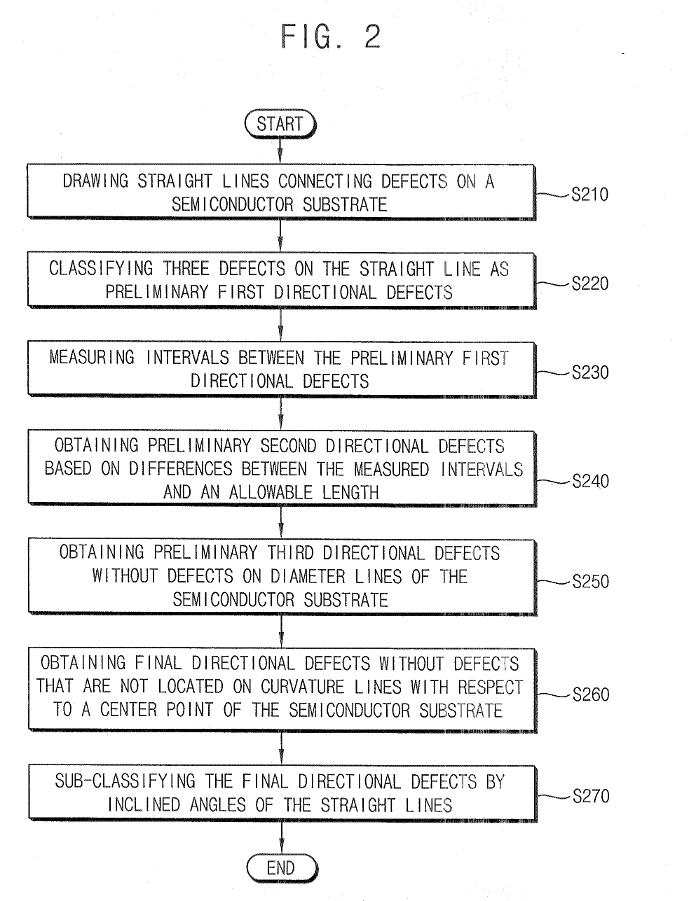

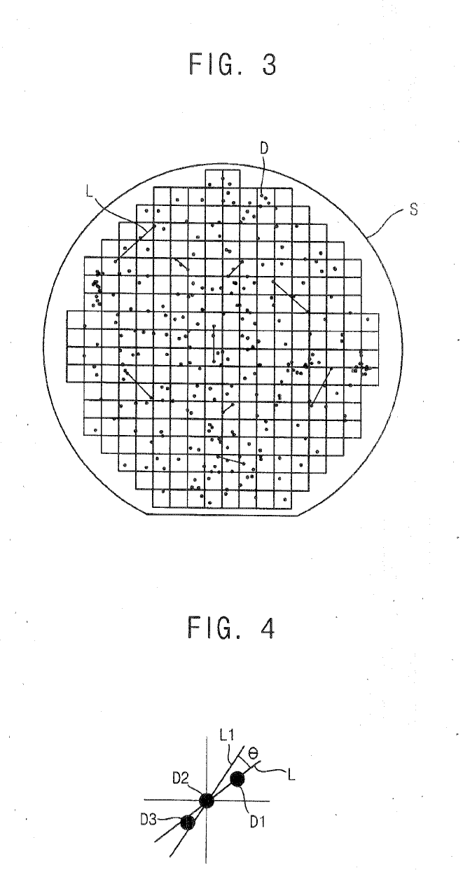

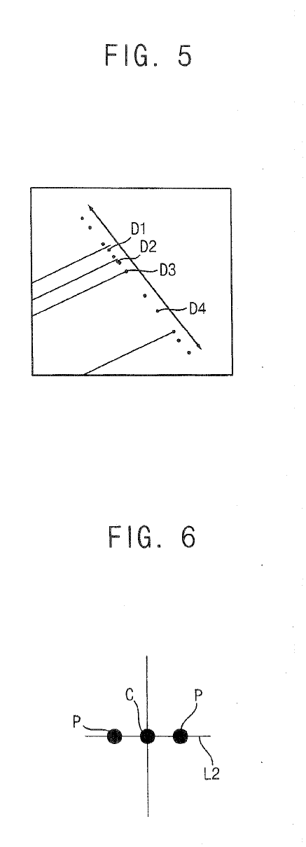

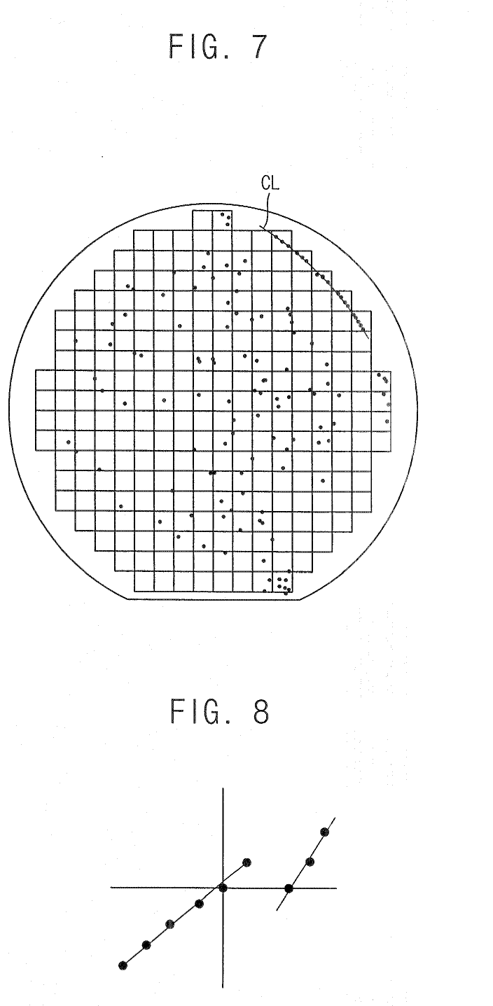

FIG. 2 is a flow chart illustrating a method of classifying directional defects using the apparatus in FIG. 1 in accordance with an exemplary embodiment of the present invention, FIG. 3 is a plan view illustrating a process for drawing straight lines on a semiconductor substrate, FIG. 4 is an enlarged plan view illustrating a process for classifying preliminary first directional defects, FIG. 5 is an enlarged plan view illustrating a process for classifying preliminary second directional defects, FIG. 6 is an enlarged plan view illustrating a process for classifying preliminary third directional defects, FIG. 7 is a plan view illustrating a process for classifying final directional defects, and FIG. 8 is a plan view illustrating a process for sub-classifying the final directional defects.

First of all, all of the defects D on a semiconductor substrate S on which a CMP process has been carried out are detected. Referring to FIG. 3, positions of all of the defects D are shown as dots on the semiconductor substrate S.

Referring to FIGS. 2 and 3, in step S210, the drawing unit 110 draws straight lines L connecting three of the defects D to each other on the semiconductor substrate S.

Referring to FIGS. 2 and 4, in step S220, the defect-classifying unit 130 sub-classifies three defects, for example, first to third defects D1, D2, and D3 placed on the straight line L as preliminary first directional defects. More specifically, the drawing unit 110 draws an auxiliary straight line L1 that passes through a center of the second defect D2 and is inclined by an allowable angle θ, i.e., about ±1.5° with respect to the straight line L. The first to third defects D1, D2, and D3 are located within a region between the straight line L and the auxiliary straight line L1. Therefore, the defect-classifying unit 130 sub-classifies the first to third defects D1, D2, and D3 as the preliminary first directional defects.

Referring to FIGS. 2 and 5, in step S230, the interval measuring unit 120 measures intervals between the preliminary first directional defects. More specifically, the interval-measuring unit 120 measures a first interval between the first defect D1 and the second defect D2.

In step S240, when the first interval is within the allowable length, that is, about 40 μm, the defect-classifying unit 130 sub-classifies the first and second defects D1 and D2 as preliminary second directional defects.

The interval-measuring unit 120 then measures a second interval between the second defect D2 and the third defect D3. When the second interval is within the allowable length, the defect-classifying unit 130 sub-classifies the second and third defects D2 and D3 as the preliminary second directional defects.

The interval measuring unit 120 then measures a third interval between the third defect D3 and a fourth defect D4. In the case where the third interval exceeds the allowable length, the defect-classifying unit 130 excludes the fourth defect D4 from the preliminary first directional defects.

Therefore, although the first to fourth defects D1, D2, D3 and D4 are located within the allowable angle with respect to the straight line L, when the fourth defect D4 is placed on a position that is spaced apart from the third defect D3 by the excess length, as shown in FIG. 5, the defect classifying unit 130 excludes the fourth defect D4 from the preliminary first directional defects. As a result, the preliminary second directional defects only include the first to third defects D1, D2 and D3 excluding the fourth defect D4.

Referring to FIGS. 2 and 6, in step S250, the defect classifying unit 130 recognizes whether a straight line L2 connecting the preliminary second directional defects to each other passes through the center point C of the semiconductor substrate S or not. When the straight line L2 corresponds to a diametrical line of the semiconductor substrate S, defects P on the straight line L2 among the preliminary second directional defects are not caused by the CMP process. This is shown in FIG. 6. Thus, the defect-classifying unit 130 excludes the defects P on the straight line L2 from the preliminary second directional defects to obtain preliminary third directional defects.

Referring to FIGS. 2 and 7, in step S260, the drawing unit 110 draws curvature lines CL, which connect the preliminary third directional defects to each other, with respect to the center point of the semiconductor substrate S. Defects that are not located on the curvature lines CL do not correspond to the directional defects caused by the CMP process. Therefore, the defect-classifying unit 130 excludes the defects offset from the curvature lines CL from the preliminary third directional defects to obtain final directional defects.

In this exemplary embodiment the final directional defects are obtained by the primary classification using the straight lines, by the secondary classification using the distances, by the tertiary classification using the diametrical lines, and by the quartic classification using the curvature lines. Thus, most of the final directional defects may be regarded as the directional defects generated in the CMP process.

Additionally, referring to FIGS. 2 and 8, in step S270, the defect-classifying unit 130 sub-sub-classifies the final directional defects by inclined angles of the straight lines that connect the final directional defects to each other, as shown in FIG. 8. The sub-classified final directional defects may be generated by different causes in the CMP process. Therefore, the number of the directional defects, that is, the micro-scratches generated only in the CMP process may be accurately recognized.

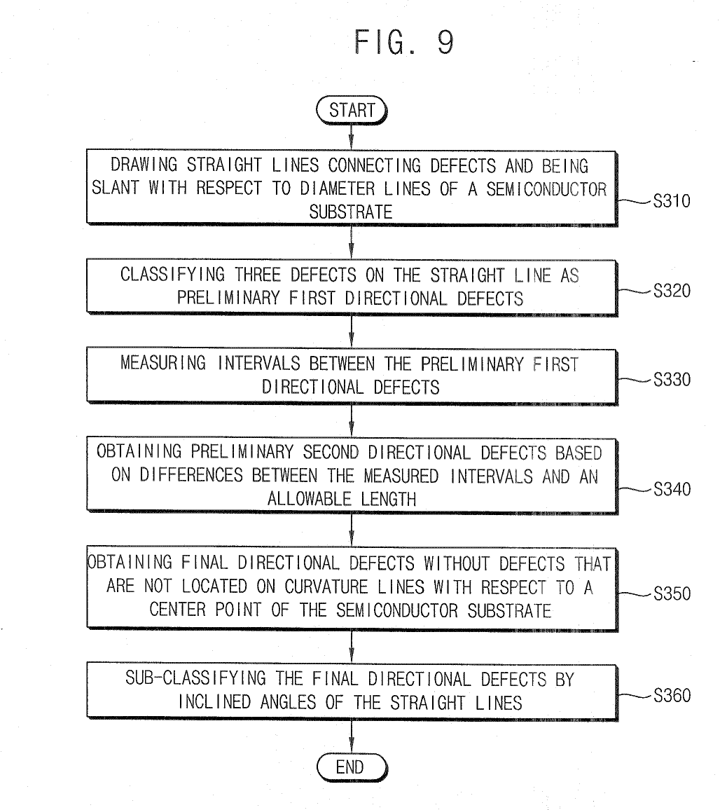

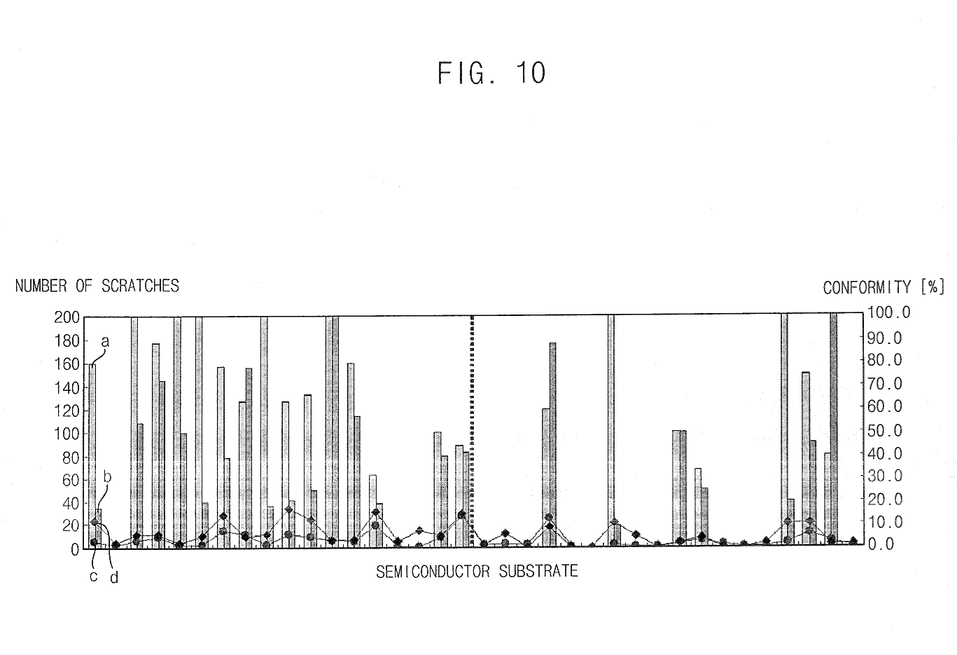

FIG. 9 is a flow chart illustrating a method of classifying directional defects using the apparatus in FIG. 1 in accordance with embodiment of the present invention.

Referring to FIGS. 1 and 9, in step S310, the drawing unit 110 draws straight lines connecting the defects to each other on the semiconductor substrate. In this exemplary embodiment, the straight lines do not pass through the center point of the semiconductor substrate. That is, the drawing unit 110 does not draw the diametrical lines passing through the center point of the semiconductor substrate. Thus, the method of this exemplary embodiment does not include the step S250 for excluding the defects on the diametrical lines from the directional defects in accordance with the method shown in FIG. 2.

In step S320, the defect-classifying unit 130 sub-classifies at least three defects within the allowable angle with respect to the straight line, such as L in FIG. 4, as preliminary first directional defects.

In step S330, the interval-measuring unit 120 measures intervals between the preliminary first directional defects.

In step S340, when an interval exceeds the allowable length, the defect-classifying unit 130 excludes a corresponding defect, such as D4 in FIG. 5, spaced apart by the excess length from the preliminary first directional defects to obtain preliminary second directional defects.

In step S350, the drawing unit 110 draws curvature lines, which connect the preliminary third directional defects to each other, with respect to the center point of the semiconductor substrate. The defect-classifying unit 130 excludes defects that are not located on the curvature lines from the preliminary second directional defects to obtain final directional defects.

In step S360, the defect-classifying unit 130 sub-sub-classifies the final directional defects by inclined angles of the straight lines that connect the final directional defects to each other.

First Evaluation of Conformity on Classifying Directional Defects using an Exemplary Method of the Present Invention

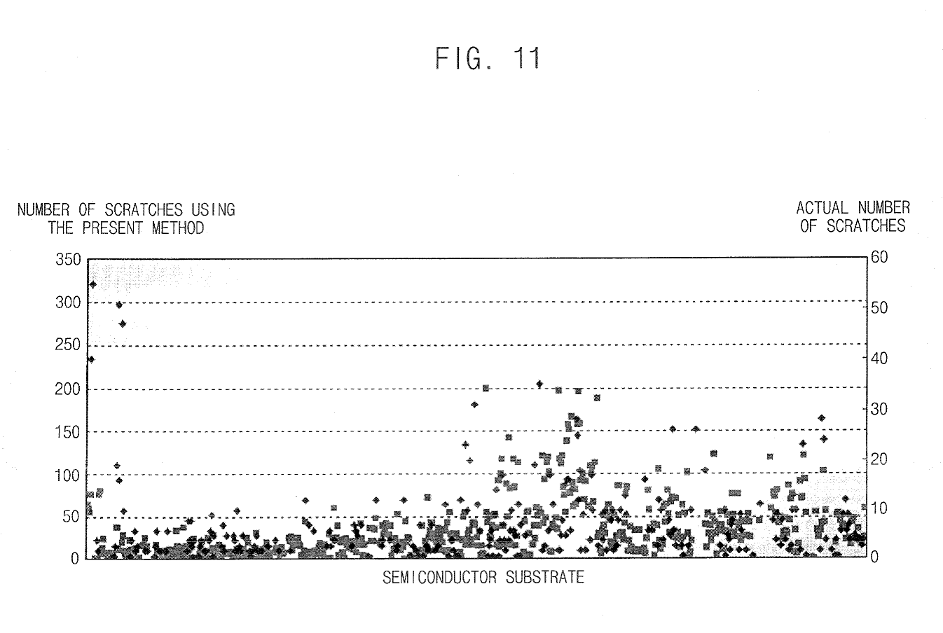

CMP processes are respectively carried out on insulation layers formed on semiconductor substrates. Micro-scratches generated in performing the CMP process are classified from the other defects on each of the semiconductor substrates by using an exemplary method of the present invention. The results are shown in FIG. 10.

In FIG. 10, a horizontal axis represents a semiconductor substrate, a left vertical axis indicates the number of micro-scratches appearing thereon, and a right vertical axis represents percentage conformity (%).

More specifically, a bar “a” indicates an accuracy that means a ratio between the number of micro-scratches, which are caused by the CMP process, measured using the exemplary method of the present invention, and the number of all the defects. A bar “b” represents a purity which means a ratio between the actual number of the micro-scratches, which are actually caused by the CMP process, and the measured number of the micro-scratches using the exemplary method. Further, a line “c” indicates the number of micro-scratches measure using the exemplary method, and a line “d” represents the actual number of the micro-scratches. Thus, a high purity means a good classifying capacity.

As shown in FIG. 10, the actual classifying capacity is relatively large and turns out to be very close to an anticipated classifying capacity. Therefore, it can be noted that the exemplary method may accurately classify the micro-scratches caused by the CMP process from all the defects on the semiconductor substrate.

Second Evaluation of Conformity using an Exemplary Method of the Present Invention

CMP processes are respectively carried out on insulation layers formed on semiconductor substrates. Micro-scratches generated during the CMP process on each of the semiconductor substrates are classified from the other defects by using an exemplary method of the present invention. The results are shown in FIG. 11.

In FIG. 11, the horizontal axis represents a semiconductor substrate, a left vertical axis indicates the measured number of the micro-scratches using the present exemplary method, and a right vertical axis represents the actual number of micro-scratches. Further, a point ▪ indicates the measured number of micro-scratches using the present exemplary method, and a point ♦ represents the actual number of the micro-scratches actually generated in the CMP process.

As shown in FIG. 11, the points ▪ are located adjacent the points ♦. Therefore, it can be noted that the present exemplary method may have a good classifying capacity of the micro-scratches in the CMP process.

According to an exemplary embodiment of the present invention, after performing a CMP process, only the directional defects among all the defects that are located on the semiconductor substrate may be accurately classified. Further, an accurate number of the classified directional defects may be obtained. As a result, the CMP process may be effectively managed.

Having described exemplary embodiments of the present invention, it is noted that modifications and variations can be made by persons of ordinary skill in the art in light of the above teachings. It is therefore to be understood that changes may be made in exemplary embodiments of the present invention as disclosed which are within the scope and the spirit of the invention outlined by the appended claims.

What is claimed is:

1. A method of classifying directional defects on an object comprising:
drawing straight lines from any defect among all defects on the object toward adjacent defects; and
classifying at least three defects substantially positioned on each of the straight lines as directional defects.

2. The method of claim 1, wherein the straight lines are drawn at a slant with respect to diametrical lines of the object to thereby exclude defects on the diametrical lines.

3. The method of claim 1, wherein classifying the directional defects comprises classifying defects within a predetermined allowable angle with respect to the straight lines as the directional detects.

4. The method of claim 3, wherein the predetermined allowable angle is about ±1.5° with respect to the straight line.

5. The method of claim 1, further comprising:
measuring distances between the directional defects; and
excluding defects, which are spaced apart from the directional defect by an excess length greater than a predetermined allowable length, from the directional defects.

6. The method of claim 5, wherein the allowable length is about 40 μm.

7. The method of claim 1, further comprising:
drawing diametrical lines that pass through a center point of the object; and
excluding defects from the directional defects on the diametrical lines.

8. The method of claim 1, further comprising excluding defects, which are not located on curvature lines with respect to a center point of the object, from the directional defects.

9. The method of claim 1, further comprising sub-classifying the directional defects by inclined angles of the straight lines.

10. The method of claim 1, wherein the object comprises a semiconductor substrate, and the directional defects comprises micro-scratches on the semiconductor substrate generated in a chemical mechanical polishing process.

11. A method of classifying directional defects on a semiconductor substrate, comprising;
drawing straight lines from any defect among all defects on the semiconductor substrate toward adjacent defects;
classifying at least three defects substantially positioned on each of the straight lines as preliminary first directional defects;
measuring intervals between the preliminary first directional defects;
excluding defects, which are spaced apart from the preliminary first directional defect by an excess length greater than a predetermined allowable length, from the preliminary first directional defects to obtain preliminary second directional defects;
excluding defects, which are located on diametrical lines of the semiconductor substrate, from the preliminary second directional defects to obtain preliminary third directional defects; and
excluding defects, which are not located on curvature lines with respect to a center point of the semiconductor substrate, from the preliminary third directional defects to obtain final directional defects.

12. The method of claim 11, wherein classifying the preliminary first directional defects comprises classifying defects within an allowable angle of about ±1.5° with respect to the straight lines as the preliminary first directional defects.

13. The method of claim 11, wherein the predetermined allowable length is about 40 μm.

14. The method of claim 11, further comprising sub-classifying the directional defects by inclined angles of the straight lines.

15. A method of classifying directional defects on a semiconductor substrate, comprising:
drawing straight lines, which do not pass through a center point of the semiconductor substrate, from any defect among all defects on the semiconductor substrate toward adjacent defects;
classifying at least three defects substantially positioned on each of the straight lines as preliminary first directional defects;
measuring intervals between the preliminary first directional defects;
excluding defects, which are spaced apart from the preliminary first directional defect by an excess length greater than, a predetermined allowable length, from the preliminary first directional defects to obtain preliminary second directional defects; and
excluding defects, which are not located on curvature lines with respect to a center point of the semiconductor substrate, from the preliminary second directional defects to obtain final directional defects.

16. The method of claim 15, wherein classifying the preliminary first directional defects comprises classifying defects within an allowable angle with respect to the straight lines as the preliminary first directional defects.

17. The method of claim 15, further comprising sub-classifying the directional defects by inclined angles of the straight lines.

18. An apparatus for classifying directional defects on an object, comprising:
a drawing unit for drawing straight lines from any defect among defects on the object toward adjacent defects; and
a defect-classifying unit for differentiating at least three defects within an allowable angle with respect to each of the straight lines as directional defects.

19. The apparatus of claim 18, further comprising an interval-measuring unit for measuring intervals between the directional defects, wherein the defect-classifying unit excludes defects, which are spaced apart from the directional defect by excess length greater than a predetermined allowable length, from the directional defects.

20. The apparatus of claim 18, wherein the drawing unit draws curvature lines with respect to a center point of the object, and wherein the defect-classifying unit excludes defects, which are placed on diametrical lines of the object among the straight lines and defects, which are not located on the curvature lines, from the directional defects, and sub-classifies the directional defects by inclined angles of the straight lines.
